(19) United States
(12) Patent Application Publication
(10) Pub. No.: US 2018/0111091 A1
(43) Pub. Date: Apr. 26, 2018

(54) FILTER CARTRIDGE WITH INDEPENDENTLY REPLACEABLE FILTER ASSEMBLY

(71) Applicant: Zhongshan Filterpro Environmental Protection Technology, LLC, Zhongshan City (CN)

(72) Inventors: Bingbing LI, Zhongshan City (CN); Li JIANG, Zhongshan City (CN); Zhenlong HUANG, Zhongshan City (CN); Wenfeng DENG, Zhongshan City (CN)

(21) Appl. No.: 15/549,806

(22) PCT Filed: Sep. 1, 2016
(86) PCT No.: PCT/CN2016/097814

§ 371 Date: Nov. 15, 2017

(30) Foreign Application Priority Data
Dec. 30, 2015 (CN) 201511030341.4

(51) Int. Cl. B01D 61/04; C02F 1/44; B01D 61/02; B01D 29/01; C02F 1/00; B01D 61/08; B01D 29/96

(52) U.S. Cl. CPC B01D 61/04; C02F 1/441; B01D 61/025; B01D 2311/2649; C02F 1/001; B01D 61/08; B01D 29/96; B01D 29/016

(57) ABSTRACT

Disclosed is a filter cartridge with independently replaceable filter assembly, comprising a shell with a cavity and opening, a filter body is arranged in the cavity, a cover plate capable of sealing the opening is further detachably arranged at the opening of the cavity, a water inlet for raw water to flow in, a waste water outlet for waste water to flow out and a purified water outlet for filtered liquid to flow t are further formed. in the shell respectively, and the filter body is formed by mutually sleeving at least two independent filter assemblies. Because the filter body is formed by mutually sleeving more than two independent filter assemblies, some of the filter assemblies, with the due service life, of the filter cartridge can be independently replaced without replacement of the whole filter body so that cost for using the filter cartridge can be reduced, the filter assemblies with the service life not due can also be prevented from being abandoned, thus saving social resources.

### FIELD OF THE INVENTION

The present disclosure relates to a filter cartridge.

### BACKGROUND OF THE INVENTION

It is well known that a filter cartridge mainly relies on its internal filter body to filter liquid. When used for a period of time, the filter body cannot filter impurities in the liquid any longer, and then the user will need to replace a new filter cartridge.

The filter body of the existing filter cartridge is generally composed of a plurality of layers of filter assemblies some of which are used to absorb the impurities in the liquid and some of which are used to limit the impurities in the liquid from passing through the filter assemblies, different filter assemblies have different service life, and the existing filter body is generally formed unitarily, so the service life of the filter body is determined by the filter assembly having the shortest service life.

When the filter assembly having the shortest service life reaches the limit of use, the user needs to replace the entire filter body of the filter cartridge. Some of the filter assemblies in the filter body that are replaced can also be used for a long time, so that replacing the entire filter body not only increases the use cost for users, but also leads to that the filter assemblies capable of continuing to use a long time is thrown away, resulting in waste of resources.

### SUMMARY OF THE INVENTION

In order to solve the above problems, the present disclosure aims at providing a filter cartridge with a simple structure and with independently replaceable filter assembly.

In order to solve the technical problems, the present disclosure employs the technical solutions as follows:

A filter cartridge with independently replaceable filter assembly comprises a shell with a cavity and an opening, wherein a filter body is arranged in the cavity, a cover plate capable of sealing the opening is further detachably arranged at the opening of the cavity meanwhile, a water inlet for raw water to flow in, a waste water outlet for waste water to flow out, and a purified water outlet for filtered liquid to flow out are further formed in the shell respectively, and the filter body is formed by mutually sleeving at least two independent filter assemblies.

As an improvement of the above technical solution, the filter body is formed by mutually sleeving three independent filter assemblies, and the filter body comprises an outside filter assembly, an intermediate filter assembly and an inside filter assembly in sequence from outside to inside.

As an improvement of the above technical solution, the outside filter assembly, the intermediate filter assembly and the inside filter assembly are a carbon rod, an RO film and a carbon rod respectively.

In the present disclosure, the outside filter assembly, the intermediate filter assembly and the inside filter assembly are a folded paper filter layer, an RO film and a carbon rod respectively.

Preferably, an outside upper end cover and an outside lower end cover capable of preventing liquid from entering inside from two ends of the outside filter assembly are arranged on an upper end face and a lower end face of the outside filter assembly respectively.

Further, an inside upper end cover and an inside lower end cover capable of preventing liquid from entering inside from two ends of the inside filter assembly are arranged on an upper end face and a lower end face of the inside filter assembly respectively, and a purified water channel communicated with the purified water outlet is further opened in the inside upper end cover or the inside lower end cover.

Still further, a groove convenient for the intermediate filter assembly to plug in is further arranged in a surface of one side of the cover plate facing towards the cavity.

As a preferred embodiment of the present disclosure, the water inlet and the waste water outlet are arranged in the cover plate, and are located outside and inside of the groove respectively, and the purified water outlet is arranged in a bottom wall of the cavity meanwhile.

The present disclosure has the beneficial effects as follows: due to the fact that the filter body is formed by mutually sleeving more than two independent filter assemblies, some of the filter assemblies, with the due service life, of the filter cartridge can be independently replaced without the replacement of the whole filter body so that the cost for using the filter cartridge can be reduced for users, the filter assemblies with the service life not due can also be prevented from being abandoned, and thus saving social resources.

### BRIEF DESCRIPTION OF THE DRAWINGS

The present disclosure will be further described in details hereinafter with reference to the drawings and the specific embodiments.

FIG. 1 is a schematic view of exterior of a filter cartridge according to a preferred embodiment of the present disclosure;

FIG. 2 is a schematic view of exterior of the filter cartridge from another perspective according to a preferred embodiment of the present disclosure;

FIG. 3 is a schematic view of interior of the filter cartridge according to a preferred embodiment of the present disclosure;

FIG. 4 is a schematic partial exploded view of a preferred embodiment of the present disclosure; and

FIG. 5 is a schematic exploded view of the filter cartridge according to a preferred embodiment of the present disclosure.

### DETAILED DESCRIPTION OF THE EMBODIMENTS

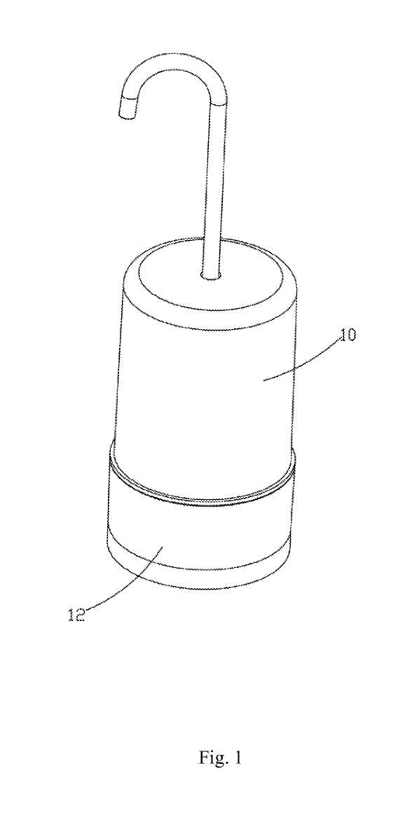

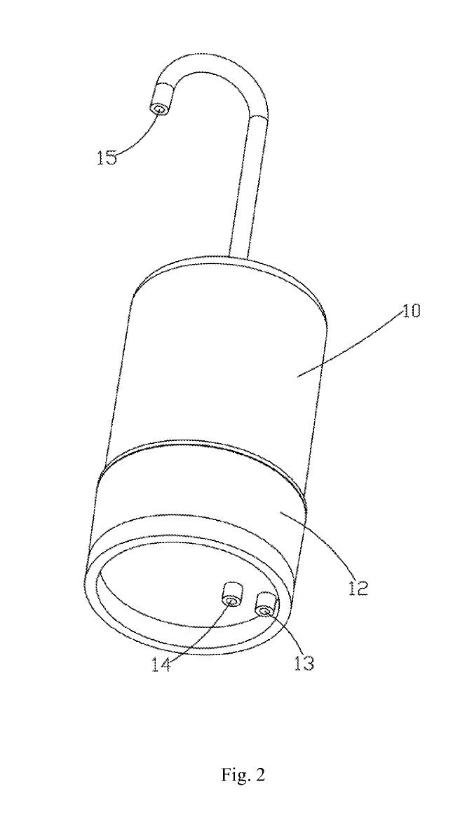

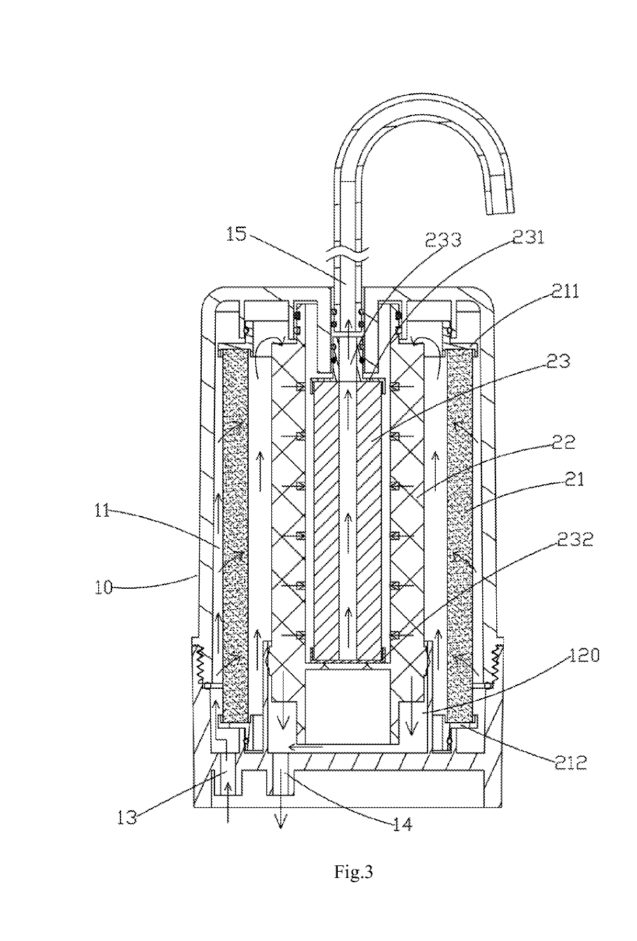

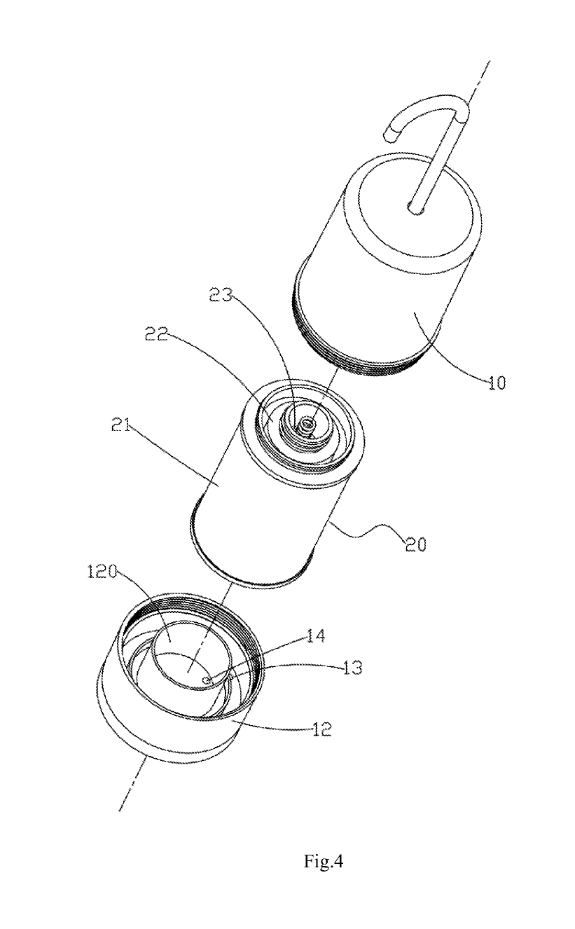

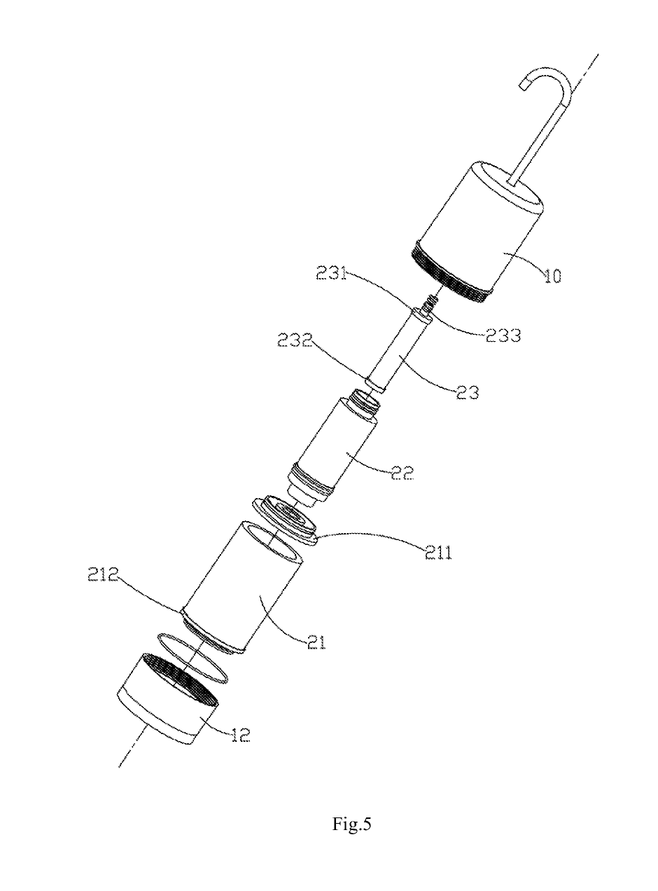

Referring to FIG. 1 to FIG. 5 (the direction of an arrow in FIG. 3 shows a flowing direction of liquid), a filter cartridge with independently replaceable filter assembly comprises a shell 10 with an cavity 11 and an opening, wherein a filter body 20 is arranged in the cavity 11, a cover plate 12 capable of sealing the opening is further detachably arranged at the opening of the cavity 11 meanwhile. Preferably, the cover plate 12 is threadedly connected to the opening of the cavity 11 herein. Of course, the cover plate 12 may also be clampingly mounted on the shell 10. A water inlet 13 for raw water to flow in, a waste water outlet 14 for waste water to flow out, and a purified water outlet 15 for filtered liquid to flow out are further formed in the shell 10 respectively, and the filter body 20 is formed by mutually sleeving at least two independent filter assemblies.

Due to the fact that the filter body is formed by mutually sleeving more than two independent filter assemblies, some of the filter assemblies, with the due service life, of the filter cartridge can be independently replaced without the replacement of the whole filter body so that the cost for using the filter cartridge can be reduced for users, the filter assemblies with the service life not due can also be prevented from being abandoned, and thus saving social resources.

For a more efficient filtering, preferably, the filter body 20 of the present disclosure is formed by mutually sleeving three independent filter assemblies herein, the filter body 20 comprises an outside filter assembly 21, an intermediate filter assembly 22 and an inside filter assembly 23 in sequence from outside to inside. In the present disclosure, the outside filter assembly 21, the intermediate filter assembly 22 and the inside filter assembly 23 are a carbon rod, an RO film and a carbon rod respectively. In addition, the outside filter assembly 21, the intermediate filter assembly 22 and the inside filter assembly 23 may also be other filter assemblies, for example, the outside filter assembly 21, the intermediate filter assembly 22 and the inside filter assembly 23 may be a folded paper filter layer, an RO film and a carbon rod respectively. Of course, the outside filter assembly 21, the intermediate filter assembly 22 and the inside filter assembly 23 may also be made of other filter materials. The filter body 20 of the filter cartridge of the present disclosure is arranged as the outside filter assembly 21, the intermediate filter assembly 22 and the inside filter assembly 23, so that the liquid to be filtered can be filtered more thoroughly and efficiently when passing through the outside filter assembly 21, the intermediate filter assembly 22 and the inside filter assembly 23 in sequence.

In order to enable the liquid to be filtered to pass through the outside filter assembly 21, the intermediate filter assembly 22 and the inside filter assembly 23 in sequence, preferably, an outside upper end cover 211 and an outside lower end cover 212 capable of preventing liquid from entering inside from two ends of the outside filter assembly 21 are arranged on an upper end face and a lower end face of the outside filter assembly 21 respectively. The outside upper end cover 211 and the outside lower end cover 212 are connected with an inner wall at the bottom of the cavity 11 and an inner wall at the bottom of the cover plate 12 via a seal ring respectively, and only passing through the outside filter assembly 21 can water to be filtered contact with the intermediate filter assembly 22 and the inside filter assembly 23 therein via the arrangement of the outside upper end cover 211 and the outside lower end cover 212.

Further, in order to enable the liquid to have to pass through the intermediate filter assembly 22 and to be filtered by the intermediate filter assembly 22, in the present disclosure, a groove 120 that is convenient for the intermediate filter assembly 22 to plug in is further arranged in a surface of one side of the cover plate 12 facing towards the cavity 11. When mounting, the intermediate filter assembly 22 is plugged in the groove 120, and two ends of the intermediate filter assembly 22 are connected with the inner wall at the bottom of the cavity 11 and the inner wall of the groove 120 via a sealed ring respectively. Therefore, only passing through the intermediate filter assembly 22 can the liquid to be filtered contact with the inside filter assembly 23 therein.

Further, in order to enable the liquid to have to be filtered through the inside filter assembly 3 and then to flow to the purified water outlet, in the present disclosure, an inside upper end cover 231 and an inside lower end cover 232 capable of preventing liquid from entering inside from two ends of the inside filter assembly 23 are arranged on an upper end face and a lower end face of the inside filter assembly 23 respectively. A purified water channel 233 communicated with the purified water outlet 15 is further opened in the inside upper end cover 231 or the inside lower end cover 232, the purified water channel 233 and the purified water outlet 15 are sealed via a seal ring, therefore, only the liquid passing through the inside filter assembly 23 can enter into the purified water outlet 15 through the purified water channel 233, ensuring that the liquid flowing out from the purified water outlet 15 is filtered several times, so as to ensure the filter quality.

Still further, in order to make the structure of the filter cartridge of the present disclosure more reasonable, preferably, the water inlet 13 and the waste water outlet 14 are arranged in the cover plate 12, and are located outside and inside of the groove 120 respectively, and the purified water outlet 15 is arranged in a bottom wall of the cavity 11 meanwhile. Of course, the purified water outlet 15, the water inlet 13 and the waste water inlet 14 may also be arranged in different positions of the shell 10.

The above description is merely the preferred embodiments of the disclosure, and any technical solution achieving the object of the disclosure via the basically same means shall all fall within the protection scope of the disclosure.

1. A filter cartridge with independently replaceable filter assemblies, comprising:
a shell with an cavity and an opening, in which a water inlet for raw water to flow in, a waste water outlet for waste water to flow out, and a purified water outlet for filtered liquid to flow out are formed respectively;
a filter body arranged in the cavity;
a cover plate detachably arranged at the opening of the cavity, the cover plate is capable of sealing the opening;
wherein the filter body is formed by mutually sleeving at least two independent filter assemblies.

2. The filter cartridge with independently replaceable filter assembly according to claim 1, wherein the filter body is formed by mutually sleeving three independent filter assemblies, and the filter body comprises an outside filter assembly, an intermediate filter assembly and an inside filter assembly in sequence from outside to inside.

3. The filter cartridge with independently replaceable filter assembly according to claim 2, wherein the outside filter assembly, the intermediate filter assembly and the inside filter assembly are a carbon rod, an RO film and a carbon rod respectively.

4. The filter cartridge with independently replaceable filter assembly according to claim 2, wherein the outside filter assembly, the intermediate filter assembly and the inside filter assembly are a folded paper filter layer, an RO film and a carbon rod respectively.

5. The filter cartridge with independently replaceable filter assembly according to claim 2, wherein an outside upper end cover and an outside lower end cover capable of preventing liquid from entering inside from two ends of the outside filter assembly are arranged on an upper end face and a lower end face of the outside filter assembly respectively.

6. The filter cartridge with independently replaceable filter assembly according to claim 2, wherein an inside upper end cover and an inside lower end cover capable of preventing liquid from entering inside from two ends of the inside filter assembly are arranged on an upper end face and a lower end face of the inside filter assembly respectively, and a purified water channel communicated with the purified water outlet is further opened in the inside upper end cover or the inside lower end cover.

7. The filter cartridge with independently replaceable filter assembly according to claim 2, wherein a groove convenient for the intermediate filter assembly to plug in is further arranged in a surface of one side of the cover plate facing towards the cavity.

8. The filter cartridge with independently replaceable filter assembly according to claim 7, wherein the water inlet and the waste water outlet are arranged in the cover plate, and are located outside and inside of the groove respectively, and the purified water outlet is arranged in a bottom wall of the cavity meanwhile.

9. The filter cartridge with independently replaceable filter assembly according to claim 3, wherein an outside upper end cover and an outside lower end cover capable of preventing liquid from entering inside from two ends of the outside filter assembly are arranged on an upper end face and a lower end face of the outside filter assembly respectively.

10. The filter cartridge with independently replaceable filter assembly according to claim 4, wherein an outside upper end cover and an outside lower end cover capable of preventing liquid from entering inside from two ends of the outside filter assembly are arranged on an upper end face and a lower end face of the outside filter assembly respectively.

11. The filter cartridge with independently replaceable filter assembly according to claim 3, wherein an inside upper end cover and an inside lower end cover capable of preventing liquid from entering inside from two ends of the inside filter assembly are arranged on an upper end face and a lower end face of the inside filter assembly respectively, and a purified water channel communicated with the purified water outlet is further opened in the inside upper end cover or the inside lower end cover.

12. The filter cartridge with independently replaceable filter assembly according to claim 4, wherein an inside upper end cover and an inside lower end cover capable of preventing liquid from entering inside from two ends of the inside filter assembly are arranged on an upper end face and a lower end face of the inside filter assembly respectively, and a purified water channel communicated with the purified water outlet is further opened in the inside upper end cover or the inside lower end cover.
